(19) United States
(12) Patent Application Publication
(10) Pub. No.: US 2024/0142008 A1
(43) Pub. Date: May 2, 2024

(54) ISOLATION VALVE

(71) Applicant: MATSUIKIKI INDUSTRIES CO., LTD., Nagahama-shi (JP)

(72) Inventors: Sadanori MATSUI, Nagahama-shi (JP); Takashi KITAGAWA, Nagahama-shi (JP); Yukikazu TERADA, Nagahama-shi (JP)

(21) Appl. No.: 18/489,005

(22) Filed: Oct. 18, 2023

Related U.S. Application Data
(60) Provisional application No. 63/419,713, filed on Oct. 27, 2022.

(51) Int. Cl. F16K 11/22; F16K 27/06

(52) U.S. Cl. CPC F16K 11/22; F16K 27/065

(57) ABSTRACT

An isolation valve includes an isolation valve body, a rotatable member and a connecting member. An outer cylinder section of the rotatable member has an end portion with an increased inner diameter towards an opening that an inner cylinder section of the isolation valve body penetrates through, and has an inwardly facing annular groove on its own inner peripheral surface between the end portion and a female thread of the rotatable member. The inner cylinder section has an outwardly facing annular groove facing the inwardly facing groove on its own outer peripheral surface. The connecting member has a cross section that is sized to fit within the outwardly facing groove. The connecting member is positioned astride the inwardly facing groove and the outwardly facing groove so as to prevent a relative movement between the inner cylinder section and the rotatable member in an axial direction along a rotation axis.

### CROSS-REFERENCES TO RELATED APPLICATIONS

This patent specification claims priority to U.S. Provisional Application Ser. No. 63/419,713, filed Oct. 27, 2022, the entire contents of which are incorporated by reference herein.

### BACKGROUND OF THE INVENTION

### 1. Field of the Invention

The present invention relates to an isolation valve to be connected to a pipe for a tankless water heater.

### 2. Description of Related Art

In areas where hard water is used, minerals in the hard water tend to accumulate and become scales in the piping of tankless water heaters due to the flow of hard water which contains more minerals than soft water. In order to prevent scale from clogging the heat exchanger, a cleaning solution for scale removal is regularly circulated through the piping of the tankless water heater. To conduct the scale removal, an isolation valve is used to be connected to the pipe where the cleaning solution circulates. The isolation valve includes, for example, a connecting nut having a female thread in its connection port to be connected to the pipe for the tankless water heater. An operator connects the isolation valve to the pipe by screwing the female thread of the connecting nut onto the male thread of the pipe.

As a reference, a valve to be connected to a pipe for a tankless water heater is shown in Japanese Unexamined Patent Application Publication No. 9-159042.

### BRIEF SUMMARY OF THE INVENTION

For example, if the connecting part to the pipe is large in the isolation valve, it takes time and requires a large tool to connect the connecting port to the pipe.

One aspect of the present invention provides an isolation valve to be connected to a pipe for a tankless water heater, the pipe having a male thread, the isolation valve including:
an isolation valve body including an inner cylinder section configured to face the pipe in an axial direction along a rotation axis;
a rotatable member including an outer cylinder section, the outer cylinder section being located outside the inner cylinder section with respect to the rotation axis, and a female thread, the female thread being configured to engage with the male thread, the rotatable member being rotatably positioned relative to the inner cylinder section;
a connecting member connecting the inner cylinder section and the rotatable member relatively rotatable, wherein
the outer cylinder section has an end portion with an increased inner diameter towards an opening that the inner cylinder section penetrates through,
the outer cylinder section has an inner peripheral surface,
the outer cylinder section has an inwardly facing annular groove on the inner peripheral surface between the end portion and the female thread,
the inner cylinder section has an outer peripheral surface,
the inner cylinder section has an outwardly facing annular groove facing the inwardly facing annular groove on the outer peripheral surface,
the connecting member has a cross section that is sized to fit within the outwardly facing annular groove, and
the connecting member is positioned astride the inwardly facing annular groove and the outwardly facing annular groove so as to prevent a relative movement between the inner cylinder section and the rotatable member in the axial direction.

These and other features, aspects, and advantages of the invention will be apparent to those skilled in the art from the following detailed description of preferred non-limiting exemplary embodiments together with the drawings and the claims.

### BRIEF DESCRIPTION OF THE DRAWINGS

FIG. 1 is a schematic view showing an example of an isolation valve.

FIG. 2 is a schematic diagram illustrating section A1 in FIG. 1.

FIG. 3 is a schematic diagram showing an example of an isolation valve assembly method.

FIG. 4 is a schematic diagram illustrating a flow of water during normal use.

FIG. 5 is a schematic diagram illustrating a flow of water during cleaning.

FIG. 6 is a schematic view showing an isolation valve according to a first comparative example.

FIG. 7 is a schematic view showing an isolation valve according to a second comparative example.

### DETAILED DESCRIPTION OF THE INVENTION

Some embodiments of the present invention will be described below. Of course, the following embodiments are examples merely illustrative of the present invention, and all features shown in the embodiments may not be necessarily essential to the solution.

### (1) TECHNICAL SUMMARY OF THE PRESENT DISCLOSURE

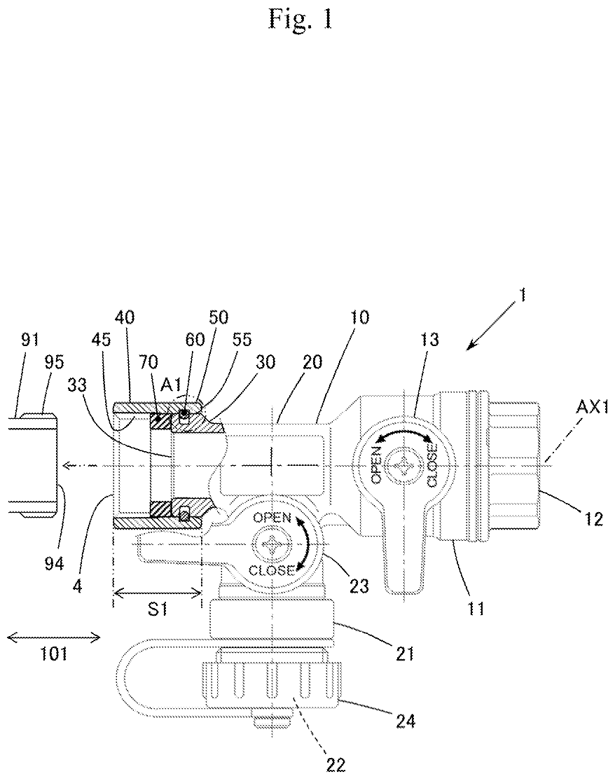

First, the technical summary of the present disclosure is given referring to examples shown in FIGS. 1-7. The figures in the present application are schematic examples, magnification ratio in each direction shown in these figures may differ, and the figures may not be consistent. Of course, each element of the present disclosure is not limited to the specific examples indicated by the reference letters.

In the present application, the numerical range “Min to Max” means the minimum value Min or more and the maximum value Max or less.

As exemplified in FIGS. 1-5, one embodiment of the present disclosure provides an isolation valve 1 to be connected to a pipe 91 for a tankless water heater 90, the pipe 91 having a male thread 95, the isolation valve 1 including an isolation valve body 10, a rotatable member (e.g. connecting nut 40) and a connecting member (e.g. C-ring 60). The isolation valve body 10 includes an inner cylinder section 30 configured to face the pipe 91 in an axial direction 101 along a rotation axis AX1. The rotatable member (40) includes an outer cylinder section 50, the outer cylinder section 50 being located outside the inner cylinder section 30 with respect to the rotation axis AX1, and a female thread 45, the female thread 45 being configured to engage with the male thread 95, the rotatable member (40) being rotatably positioned relative to the inner cylinder section 30. The connecting member (60) connects the inner cylinder section 30 and the rotatable member (40) relatively rotatable. The outer cylinder section 50 has an end portion 55 with an increased inner diameter towards an opening 57 that the inner cylinder section 30 penetrates through, and has an inwardly facing groove 52 that is annular, the inwardly facing groove 52 being on an inner peripheral surface 51 of the outer cylinder section 50 between the end portion 55 and the female thread 45. The inner cylinder section 30 has an outwardly facing groove 32 that is annular, the outwardly facing groove 32 facing the inwardly facing groove 52 on an outer peripheral surface 31 of the inner cylinder section 30. The connecting member (60) has a cross section that is sized to fit within the outwardly facing groove 32. The connecting member (60) is positioned astride the inwardly facing groove 52 and the outwardly facing groove 32 so as to prevent a relative movement between the inner cylinder section 30 and the rotatable member (40) in the axial direction 101.

The connecting member (60) positioned astride the inwardly facing groove 52 and the outwardly facing groove 32 connects the inner cylinder section 30 and the rotatable member (40) relatively rotatable, and prevents the relative movement between the inner cylinder section 30 and the rotatable member (40) in the axial direction 101. This prevents the rotatable member (40) from detaching from the inner cylinder section 30, and allows the operator to easily screw the female thread 45 of the rotatable member (40) onto the male thread 95 of the pipe 91.

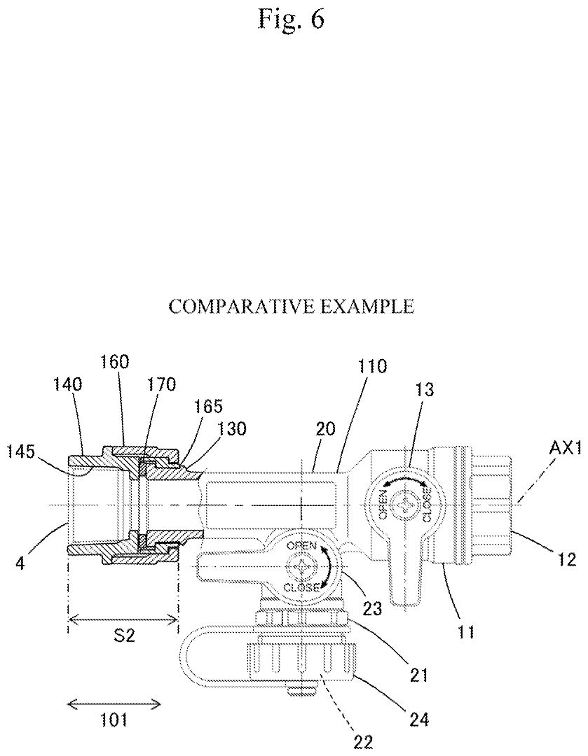

FIG. 6 schematically shows an isolation valve according to a first comparative example. The isolation valve shown in FIG. 6 includes an isolation valve body 110, a connecting nut 140, a locknut 160, an annular ring 165 and an annular packing 170. The isolation valve body 110 includes an inner cylinder section 130, a branching section 20, a first flow path section 11 having a first socket 12, a second flow path section 21 having a second socket 22, a first valve 13 and a second valve 23. In the present application, the terms “first”, “second”, . . . are used to identify each component in the plurality of components having similarities, and do not mean order. Which of the components is referred to as “first”, “second”, . . . is determined relatively. The connecting nut 140 has a female thread 145 configured to engage with the male thread of the pipe for the tankless water heater. In the isolation valve, the connecting nut 140 has a connection port 4 to the pipe. The packing 170 is inside the locknut 160 and the ring 165, and is between the connecting nut 140 and the inner cylinder section 130 in the axial direction 101.

When the operator connects the isolation valve to the pipe, he or she attaches the connecting nut 140 to the pipe's connecting fitting, and then attaches the locknut 160 to the connecting nut 140.

In the example shown in FIG. 6, there are many components for connecting to the pipe, and the length S2 of the connecting part to the pipe is long. As a result, it takes time to conduct the assembly work of connecting the isolation valve to the pipe.

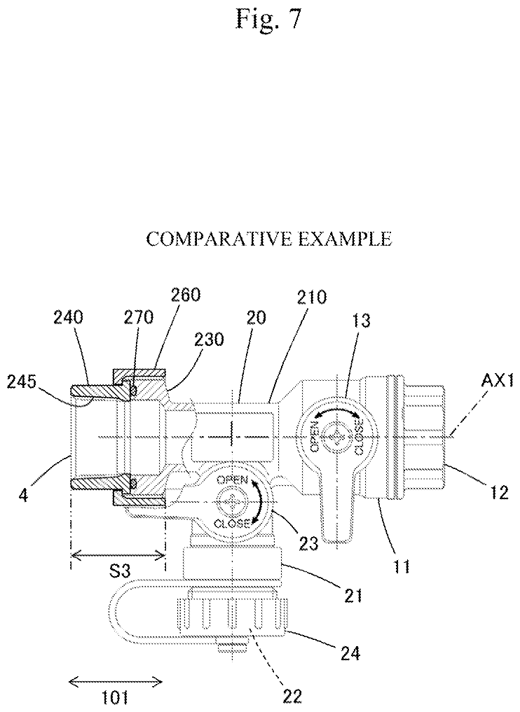

FIG. 7 schematically shows an isolation valve according to a second comparative example. The isolation valve shown in FIG. 7 includes an isolation valve body 210, a connecting nut 240, a locknut 260 and an annular packing 270. The isolation valve body 210 includes an inner cylinder section 230, a branching section 20, a first flow path section 11 having a first socket 12, a second flow path section 21 having a second socket 22, a first valve 13 and a second valve 23. The connecting nut 240 has a female thread 245 configured to engage with the male thread of the pipe for the tankless water heater. In the isolation valve, the connecting nut 240 has a connection port 4 to the pipe. The locknut 260 is engaged with the inner cylinder section 230 on the outer side of the connecting nut 240 and the inner cylinder section 230. The packing 270 is attached to an annular groove facing the connecting nut 240 in the inner cylinder section 230.

The operator can connect the isolation valve to the pipe by attaching the connecting nut 240 to the pipe's connecting fitting.

In the example shown in FIG. 7, the length S3 of the connecting part to the pipe is slightly long, and the outer diameter of the connecting part to the pipe is large. As a result, the isolation valve body 210 also increases in size. The large connecting part to the pipe requires a large tool to attach the isolation valve to the pipe, worsens workability in tight space, and results in increased work hours to attach the isolation valve to the pipe.

In the example shown in FIGS. 1-5, the connecting member (60) positioned astride the inwardly facing groove 52 and the outwardly facing groove 32 prevents the rotatable member (40) from detaching from the inner cylinder section 30. The above-mentioned embodiment of the present disclosure can provide the isolation valve having a downsized connecting part to the pipe for the tankless water heater.

The present isolation valve 1 may further include a packing 70 inside the rotatable member (40), the packing 70 being between the female thread 45 and the inner cylinder section 30. The present embodiment can suitably provide the isolation valve having the downsized connecting part to the pipe for the tankless water heater.

### (2) SPECIFIC EXAMPLES OF THE ISOLATION VALVE

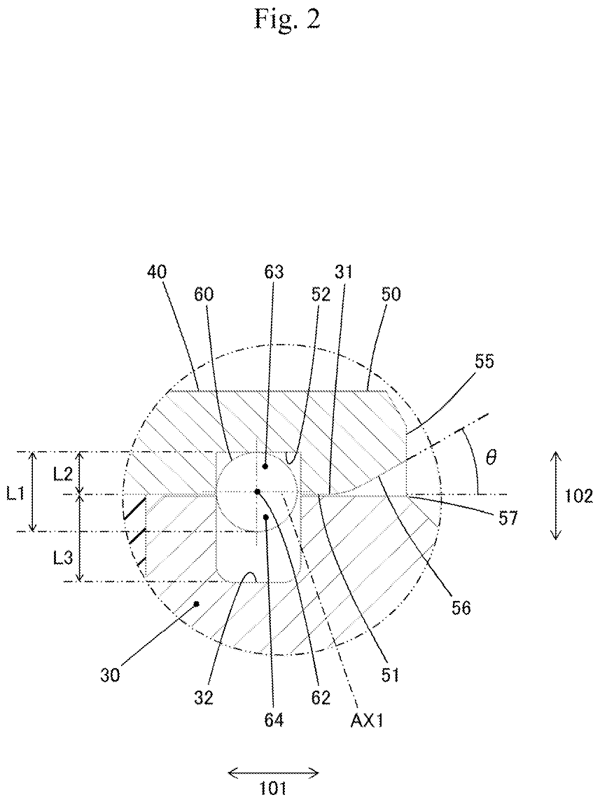

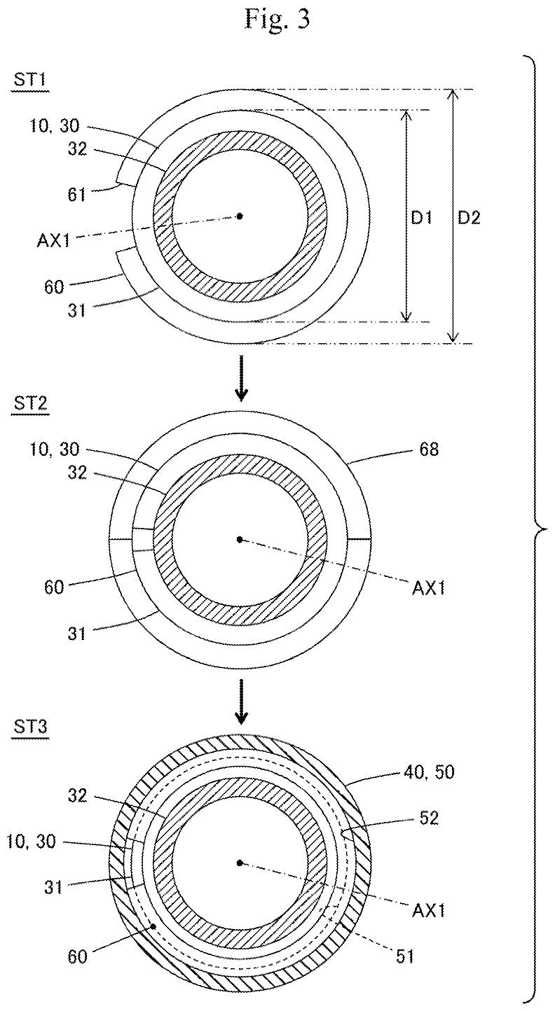

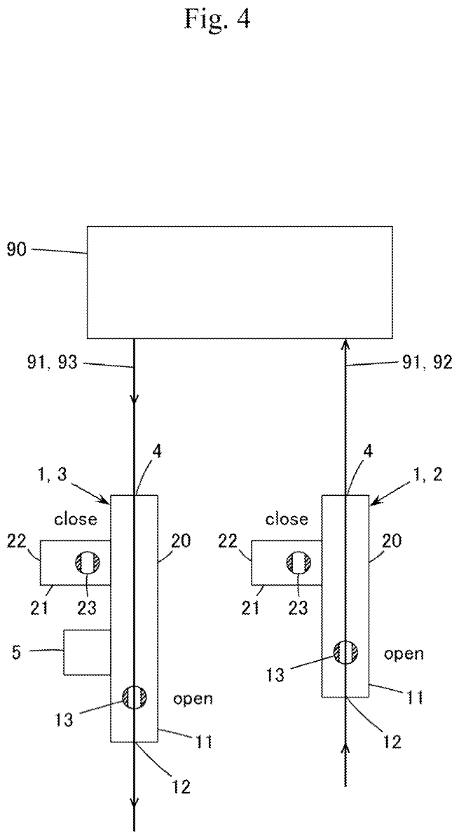

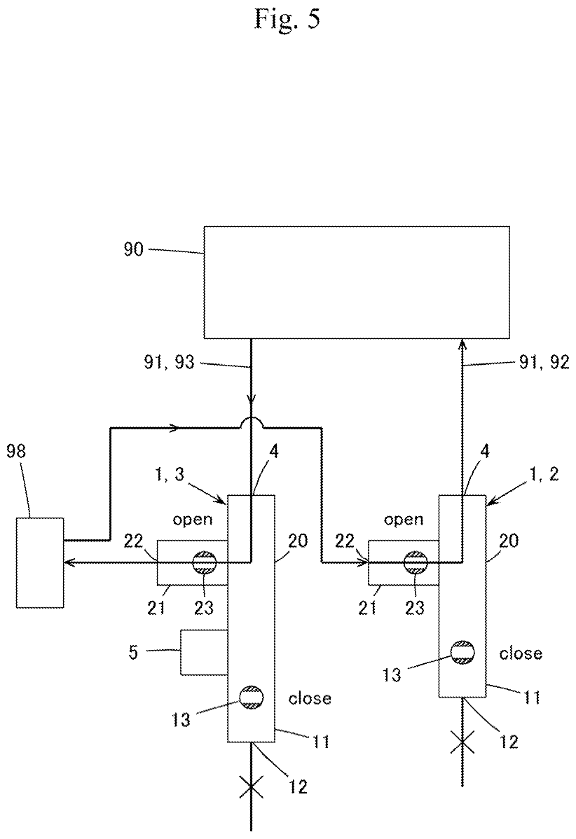

FIG. 1 schematically exemplifies the isolation valve 1. FIG. 2 schematically exemplifies the section A1 in FIG. 1. In FIG. 2, the hatching that represents the cross section of the C-ring 60 is omitted. FIG. 3 schematically exemplifies an assembly method of the isolation valve 1. FIG. 4 schematically exemplifies a flow of water during normal use. FIG. 5 schematically exemplifies a flow of water during cleaning.

The isolation valve 1 includes the isolation valve body 10, the connecting nut 40, the C-ring 60, and the packing 70 that is annular. The isolation valve 1 has a connection port 4 to be connected to the pipe 91 for the tankless water heater 90 shown in FIG. 4. The pipe 91 has the male thread 95. The connecting nut 40 substantially has the connection port 4, and has the female thread 45 configured to engage with the male thread 95 of the pipe 91. The rotation axis AX1 is an axis of a relative rotation between the connecting nut 40 and the pipe 91 during screwing. The connecting nut 40 rotates with respect to the rotation axis AX1 during screwing.

The isolation valve body 10 may include the inner cylinder section 30, a branching section 20, a first flow path section 11 having a first socket 12, a second flow path section 21 having a second socket 22, a first valve 13, and a second valve 23. The inner cylinder section 30 has an opening 33 at the tip of the inner cylinder section 30, and is configured to face an opening 94 of the pipe 91 in the axial direction 101 along the rotation axis AX1. The opening 33 of the inner cylinder section 30 is inside the outer cylinder section 50 of the connecting nut 40 with respect to the rotation axis AX1. The inner cylinder section 30 has the outwardly facing annular groove 32 facing the inwardly facing annular groove 52 of the outer cylinder section 50 on the outer peripheral surface 31. The inner cylinder section 30 may further have a part protruding from the outer cylinder section 50. The branching section 20 may branch from the part protruding from the outer cylinder section 50 in the inner cylinder section 30. The first socket 12 may be connected to an inlet pipe for water to be supplied to the tankless water heater 90 or an outlet pipe for hot water from the tankless water heater 90. The second socket 22 may be connected to an inlet pipe for cleaning solution to be supplied from a cleaning device 98 shown in FIG. 5 to the tankless water heater 90 or an outlet pipe for the cleaning solution from the tankless water heater 90. FIG. 1 shows that a cover 24 is attached to the second socket 22.

The first valve 13 is located between the branching section 20 and the first flow path section 11. When the operator performs an operation to open the first valve 13, the first flow path section 11 connects with the branching section 20. When the operator performs an operation to close the first valve 13, the first flow path section 11 is shut off from the branching section 20. Consequently, the first valve 13 can switch between connecting the branching section 20 and the first flow path section 11 and blocking the branching section 20 and the first flow path section 11.

The second valve 23 is located between the branching section 20 and the second flow path section 21. When the operator performs an operation to open the second valve 23, the second flow path section 21 connects with the branching section 20. When the operator performs an operation to close the second valve 23, the second flow path section 21 is shut off from the branching section 20. Consequently, the second valve 23 can switch between connecting the branching section 20 and the second flow path section 21 and blocking the branching section 20 and the second flow path section 21.

Example of the valves (13 and 23) include a ball valve and the like.

The connecting nut 40 is, for example, a metal member, and has the female thread 45 and the outer cylinder section 50 outside the inner cylinder section 30 with respect to the rotation axis AX1. The outer cylinder section 50 has the end portion 55 opposite the connection port 4 in the axial direction 101. The end portion 55 has the increased inner diameter towards the opening 57 that the inner cylinder section 30 penetrates through. The outer cylinder section 50 has the inwardly facing groove 52 that is annular, the inwardly facing groove 52 being on the inner peripheral surface 51 between the end portion 55 and the female thread 45. The width of the inwardly facing groove 52 is adapted to match the width of the outwardly facing groove 32. The connecting nut 40 shown in FIG. 1 is a union nut, and is rotatably positioned relative to the inner cylinder section 30. The female thread 45 of the connecting nut 40 is configured to engage with the male thread 95 of the pipe 91 by the outer cylinder section 50 rotating around the inner cylinder section 30.

The C-ring 60 is an elastic member with an arc shape exceeding 180 degrees, and has an opened part 61. The C-ring 60 is, for example, a metal member, and is positioned astride the inwardly facing groove 52 of the outer cylinder section 50 and the outwardly facing groove 32 of the inner cylinder section 30 as shown in FIG. 2. This causes the C-ring 60 to prevent the relative movement between the inner cylinder section and the connecting nut 40 in the axial direction 101. In other words, the C-ring 60 includes an outer portion 63 inside the inwardly facing groove 52 and an inner portion 64 inside the outwardly facing groove 32. This causes the C-ring 60 to relatively rotatably connect the inner cylinder section 30 and the connecting nut 40. By preventing the connecting nut 40 from detaching from the inner cylinder section 30, the operator can easily screw the female thread 45 of the connecting nut 40 onto the male thread 95 of the pipe 91. As shown in FIG. 2, the center 62 of the cross section of the C-ring 60 may be within the inwardly facing groove 52. In other words, the outer portion 63 may be wider than the inner portion 64 in the cross section of the C-ring 60. Since the center 62 is within the inwardly facing groove 52, the connecting nut 40 is less likely to detach from the inner cylinder section 30 in the axial direction 101.

The length L1 of the cross section of the C-ring 60 in the radial direction 102 orthogonal to the rotation axis AX1 is the depth L3 of the outwardly facing groove 32 or less. In other words, the cross section of the C-ring 60 is size to fit within the outwardly facing groove 32. This allows the operator to press the C-ring 60 into the outwardly facing groove 32 during assembly of the isolation valve 1 as shown in FIG. 3. The ratio L2/L1 of the length L2 of the outer portion 63 of the cross section in the radial direction 102, to the length L1, may be in a range between 0.51 and 0.70. The length L2 is the depth of the inwardly facing groove 52. Since the ratio L2/L1 is in the range between 0.51 and 0.70, the connecting nut 40 is less likely to detach further from the inner cylinder section 30 in the axial direction 101.

The length of the cross section of the C-ring 60 in the axial direction 101 is slightly shorter than the width of the inwardly facing groove 52, and is slightly shorter than the width of the outwardly facing groove 32. This causes the connecting nut 40 to rotate relative to the inner cylinder section 30, and prevents the connecting nut 40 from moving relative to the inner cylinder section 30 in the axial direction 101.

It is possible to use an elastic material for the C-ring 60, the elastic material having the outer diameter D2 with respect to the rotation axis AX1 as the center 62, the outer diameter D2 being larger than the diameter D1 of the outer peripheral surface 31 of the inner cylinder section 30 as shown in FIG. 3.

The packing 70 is, for example, a member made of elastomer having elasticity, is inside the connecting nut 40 with respect to the rotation axis AX1, and is between the female thread 45 and the inner cylinder section 30. When the pipe 91 is inserted into the connecting nut 40 from the connection port 4, the packing 70 is sandwiched between the pipe 91 and the inner cylinder section 30. This prevents water from leaking between the pipe 91 and the isolation valve body 10. Since the packing 70 is between the female thread 45 and the inner cylinder section 30 inside the connecting nut 40, it is possible to downsize the connecting part to the pipe 91 in the isolation valve 1.

The C-ring 60 is disposed between the outer cylinder section 50 and the inner cylinder section 30 according to the assembly method shown in FIG. 3. The end portion 55 of the outer cylinder section 50 has an inside surface 56 where the C-ring 60 is guided into the outwardly facing groove 32 of the inner cylinder section 30. The inside surface 56 widens towards the opening 57 with an angle θ (θ=10 to 40 degrees) with respect to the rotation axis AX1. In other words, the inside surface 56 is tapered towards the inwardly facing groove 52. Since the outer cylinder section 50 has the inside surface 56 of the angle θ, it is possible to smoothly assemble the connecting part to the pipe 91 in the isolation valve 1.

A method for manufacturing the isolation valve 1 includes steps ST1-ST3 in this order as shown in FIG. 3.
(a) the step ST1 of arranging the C-ring 60 on the outer peripheral surface 31 of the inner cylinder section 30.
(b) the step ST2 of inserting the C-ring 60 into the outwardly facing groove 32 of the inner cylinder section 30.
(c) the step ST3 of inserting part of the C-ring 60 into the inwardly facing groove 52 of the outer cylinder section 50 by inserting the inner cylinder section 30 into the outer cylinder section 50 of the connecting nut 40 from the end portion 55 (see FIG. 2) and aligning the inwardly facing groove 52 of the outer cylinder section 50 with the outwardly facing groove 32 of the inner cylinder section 30.

In the first step ST1, the operator may arrange the C-ring 60 on the outer peripheral surface 31 by inserting the opening 33 (see FIG. 1) of the inner cylinder section into the inside of the C-ring 60.

In the second step ST2, the operator may insert the C-ring 60 into the outwardly facing groove 32 by aligning the C-ring 60 with the outwardly facing groove 32 of the inner cylinder section 30 and reducing the outer diameter D2 of the C-ring 60 using an attaching tool 68 that sandwiches the C-ring 60.

In the third step ST3, the operator may insert the inner cylinder section 30 into the outer cylinder section 50 from the end portion 55, and may cause the inner peripheral surface 51 of the outer cylinder section 50 to face the outward facing groove 32 instead of the mounting tool 68. Afterward, the operator may insert the part of the C-ring 60 into the inwardly facing groove 52 by aligning the inwardly facing groove 52 with the outwardly facing groove 32. The C-ring 60 contacts the bottom of the inwardly facing groove 52 by its own elasticity.

Consequently, the connecting part to the pipe 91 in the isolation valve 1 is assembled smoothly.

As mentioned above, in the areas where hard water is used, the cleaning solution for scale removal is regularly circulated through the pipes of the tankless water heater 90. For this reason, the isolation valves 1 are connected to the pipes 91 for the tankless water heater 90 as shown in FIGS. 4 and 5. The pipes 91 include a pipe 92 for water to be supplied to the tankless water heater 90 and a pipe 93 for hot water supplied from the tankless water heater 90. The isolation valves 1 include an isolation valve 2 to be connected to the pipe 92 for a water inlet and an isolation valve 3 to be connected to the pipe 93 for a hot water outlet. The isolation valve 3 shown in FIGS. 4 and 5 includes a pressure relief valve 5 between the connection port 4 and the first valve 13.

The operator attaches the isolation valve 2 to the pipe 92 for the water inlet by screwing the connecting nut 40 of the isolation valve 2 onto a fitting of the pipe 92, and attaches the isolation valve 3 to the pipe 93 for the hot water outlet by screwing the connecting nut 40 of the isolation valve 3 onto a fitting of the pipe 93. The operator connects the inlet pipe for water to be supplied to the tankless water heater 90 to the first socket 12 of the isolation valve 2, and connects the outlet pipe for hot water from the tankless water heater 90 to the first socket 12 of the isolation valve 3.

During normal use as shown in FIG. 4, the first valves 13 of the isolation valves 2 and 3 are open, and the second valves 23 of the isolation valves 2 and 3 are closed. Water flows into the isolation valve 2 from the first socket 12, and then flows into the pipe 92 from the connection port 4 of the isolation valve 2. The tankless water heater 90 converts the water from the pipe 92 to hot water, and then discharges the hot water from the pipe 93. The hot water from the pipe 93 flows into the isolation valve 3 from the connection port 4, and then is supplied to an unshown faucet from the first socket 12 of the isolation valve 3.

During cleaning as shown in FIG. 5, the operator connects the inlet pipe for cleaning solution to the second socket 22 of the isolation valve 2 in order to supply the cleaning solution to the tankless water heater 90 from the cleaning device 98 having a pump, and connects the outlet pipe for cleaning solution to the second socket 22 of the isolation valve 3 in order to return the cleaning solution from the tankless water heater 90. The operator closes the first valves 13 of the isolation valves 2 and 3, and opens the second valves 23 of the isolation valves 2 and 3. The cleaning solution from cleaning device 98 flows into the isolation valve 2 from the second socket 22, and then flows into the pipe 92 from the connection port 4 of the isolation valve 2. The cleaning solution from the pipe 92 passes through the pipes including a heat exchanger inside the tankless water heater 90, and is discharged from the pipe 93. The cleaning solution from the pipe 93 flows into the isolation valve 3 from the connection port 4, and is returned to the cleaning device 98 from the second socket 22 of the isolation valve 3.

In the first comparative example as shown in FIG. 6, there are many components for connecting to the pipe, the length S2 of the connecting part to the pipe is long, and it takes time to conduct the assembly work of connecting the isolation valve to the pipe thereby. In the second comparative example as shown in FIG. 7, the length S3 of the connecting part to the pipe is slightly long, the outer diameter of the connecting part to the pipe is large, and thereby, workability in tight space is worse and it takes work hours to attach the isolation valve to the pipe. In FIGS. 6 and 7, elements similar to those shown in FIG. 1 are omitted from the explanation by using the same reference letters as those shown in FIG. 1.

In the specific example shown in FIGS. 1-5, the isolation valve body 10 and the connecting nut 40 are held by the C-ring 60, and the C-ring 60 is fitted into the outwardly facing groove 32 of the inner cylinder section 30 and the inwardly facing groove 52 of the outer cylinder section 50. The isolation valve 1 has a characteristic of a C-ring groove structure where the connecting nut 40 is rotatable and yet inseparable from the isolation valve body 10. As shown in FIG. 1, the length 51 of the connecting part to the pipe 91 is shorter than any of the lengths S2 and S3 shown in FIGS. 6 and 7. The present isolation valve 1 is a product that has reduced the number of components, compacted, and improved workability compared to the comparative examples.

The isolation valve 1 has the following characteristics.
(A) The connecting nut 40 is attached to the isolation valve body 10 with the C-ring 60, and is capable of rotating without moving in the axial direction 101 to be connected to the screw-in pipe 91 for the tankless water heater 90. This allows the isolation valve 1 to be directly connected to the male thread 95 of the fitting of the pipe 91, reducing the number of components and making the isolation valve 1 compact.
(B) The isolation valve 1 has the structure that part of the C-ring 60 that holds the connecting nut 40 fits into the inwardly facing groove 52 of the connecting nut 40. This structure makes the isolation valve 1 compact in the axial direction 101, and enables the packing 70 to be sandwiched between the pipe 91 and the isolation valve body 10, preventing the packing 70 from falling due to its own weight when connecting the isolation valve 1 to the pipe 91.
(C) The inwardly facing groove 52 of the connecting nut 40, the outwardly facing groove 32 of isolation valve body 10, and the C-ring 60 have positional relation that the inner portion 64 of the C-ring 60 is inside the inwardly facing groove 52 and the outer portion 63 of the C-ring 60 is inside the outwardly facing groove 32. The C-ring 60 does not move inward in the radial direction 102, and the connecting nut 40 does not detach from the isolation valve body 10.
(D) The inside surface 56 of the end portion 55 that the isolation valve body 10 is inserted into in the connecting nut 40 is tapered towards the inwardly facing groove 52.

This enables the connection part to be smoothly assembled during a process of assembling the connection part to the pipe 91 in the isolation valve 1.

### (3) VARIATIONS

Various variations of the present invention are available.

For example, the connecting member between the inner cylinder section 30 of the isolation valve body 10 and the outer cylinder section 50 of connecting nut 40 should be positioned astride the inwardly facing groove 52 and the outwardly facing groove 32, is not limited to the C-ring 60.

Since the packing 70 may be retrofit to the connection part to the pipe 91, an isolation valve without the packing 70 are also included in the present disclosure.

As long as the isolation valve 2 is connected to the pipe 92 shown in FIGS. 4 and 5, a valve different from the isolation valve 3 may be connected to the pipe 93. As long as the isolation valve 3 is connected to the pipe 93 shown in FIGS. 4 and 5, a valve different from the isolation valve 2 may be connected to the pipe 92.

### (4) CONCLUSION

As explained above, the connecting member (60) positioned astride the inwardly facing groove 52 and the outwardly facing groove 32 prevents the rotatable member (40) from detaching from the inner cylinder section 30. According to the present invention, it is possible to provide techniques including the isolation valve having a downsized connecting part to the pipe for the tankless water heater. Of course, the techniques consisting of the components in each independent claim can produce the above-mentioned primary operation and effect.

It is also possible to implement configurations formed by exchanging or combining the components disclosed in the above-mentioned examples with each another, configurations formed by exchanging or combining components in related art and the components disclosed in the above-mentioned examples with each another, etc. The present invention implies these configurations and the like.

What is claimed is:

1. An isolation valve to be connected to a pipe for a tankless water heater, the pipe having a male thread, the isolation valve comprising:
an isolation valve body including an inner cylinder section configured to face the pipe in an axial direction along a rotation axis;
a rotatable member including an outer cylinder section, the outer cylinder section being located outside the inner cylinder section with respect to the rotation axis, and a female thread, the female thread being configured to engage with the male thread, the rotatable member being rotatably positioned relative to the inner cylinder section;
a connecting member connecting the inner cylinder section and the rotatable member relatively rotatable, wherein
the outer cylinder section has an end portion with an increased inner diameter towards an opening that the inner cylinder section penetrates through,
the outer cylinder section has an inner peripheral surface,
the outer cylinder section has an inwardly facing annular groove on the inner peripheral surface between the end portion and the female thread,
the inner cylinder section has an outer peripheral surface,
the inner cylinder section has an outwardly facing annular groove facing the inwardly facing annular groove on the outer peripheral surface,
the connecting member has a cross section that is sized to fit within the outwardly facing annular groove, and
the connecting member is positioned astride the inwardly facing annular groove and the outwardly facing annular groove so as to prevent a relative movement between the inner cylinder section and the rotatable member in the axial direction.

2. The isolation valve according to claim 1, wherein
the connecting member is a C-ring.

3. The isolation valve according to claim 1, wherein
a center of the cross section of the connecting member is positioned within the inwardly facing annular groove.

4. The isolation valve according to claim 1, wherein
the connecting member has an outer portion positioned inside the inwardly facing annular groove, and
a ratio L2/L1 of the length L2 of the outer portion of the cross section in a radial direction orthogonal to the rotation axis, to the length L1 of the cross section of the connecting member in the radial direction, is in a range between 0.51 and 0.70.

5. The isolation valve according to claim 1, further comprising:
a packing inside the rotatable member, the packing being between the female thread and the inner cylinder section.

6. The isolation valve according to claim 1, wherein
the rotatable member is a union nut.

7. The isolation valve according to claim 1, wherein
the end portion of the outer cylinder section has an inside surface that widens towards the opening with an angle of 10 to 40 degrees with respect to the rotation axis.

8. The isolation valve according to claim 1, wherein
the isolation valve body includes:
a branching section branching from a part protruding from the outer cylinder section in the inner cylinder section,
a first flow path section having a first socket,
a second flow path section having a second socket,
a first valve capable of switching between connecting the branching section and the first flow path section and blocking the branching section and the first flow path section, and
a second valve capable of switching between connecting the branching section and the second flow path section and blocking the branching section and the second flow path section.
